(19) United States
(12) Patent Application Publication
(10) Pub. No.: US 2023/0048811 A1
(43) Pub. Date: Feb. 16, 2023

(54) METHODS, SYSTEMS, APPARATUSES, AND DEVICES FOR FACILITATING PROVIDING EDUCATION TO A USER

(71) Applicant: Jameel Lateef Radford, Garfield Hts., OH (US)

(72) Inventor: Jameel Lateef Radford, Garfield Hts., OH (US)

(21) Appl. No.: 17/840,799

(22) Filed: Jun. 15, 2022

Related U.S. Application Data
(60) Provisional application No. 63/233,106, filed on Aug. 13, 2021.

(51) Int. Cl. G09B 5/06; G06F 3/042; G06F 3/02

(52) U.S. Cl. CPC G09B 5/06; G06F 3/0426; G06F 3/0202

(57) ABSTRACT

A digicational smart book for facilitating providing education to a user includes a front cover comprising a first receptacle for receiving a front screen. Further, the digicational smart book may include a rear cover comprising a second receptacle for receiving a rear screen. Further, the digicational smart book may include an input device configured to receive a request from a user. Further, the digicational smart book may include a spine comprising a processing device configured for processing the request. Further, the spine may include a storage device configured for retrieving an educational module and a communication device configured for transmitting the educational module to the front screen and the rear screen. Further, the digicational smart book may include a power source configured to provide electrical energy to the front screen, the rear screen, the communication device, the processing device, and the storage device.

### FIELD OF THE INVENTION

Generally, the present disclosure relates to the field of electronic devices. More specifically, the present disclosure relates to methods, systems, apparatuses, and devices for facilitating providing education to a user.

### BACKGROUND OF THE INVENTION

The field of electronic devices is technologically important to several industries, business organizations, and/or individuals.

Technology has evolved alongside society generations after generations. As technology gradually improved over time, it has become easier to perform certain tasks and work that were previously difficult. For example, before the time of digital files, the only way of reading a textbook for school was to acquire a hard copy of a textbook. As technology improved, society has reached a point where digital files can be used rather than hard copies of a particular content such as a book. With the use of technology, it is possible to further enhance the quality of education than what it is today.

Therefore, there is a need for improved methods, systems, apparatuses, and devices for facilitating providing education to a user that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a digicational smart book for facilitating providing education to a user, in accordance with some embodiments. Accordingly, the digicational smart book may include a front cover that may include at least one first receptacle for receiving at least one front screen. Further, the front cover may be detachably attachable to a spine on a left side of the spine using a first coupling mechanism. Further, a first front part of the first coupling mechanism may be attachable to the front cover and a second front part of the first coupling mechanism may be attachable to the spine. Further, the first front part may be coupled with the second front part in a first attached state. Further, the digicational smart book may include a rear cover that may include at least one second receptacle for receiving at least one rear screen. Further, the rear cover may be detachably attachable to the spine on a right side of the spine using a second coupling mechanism. Further, a first rear part of the second coupling mechanism may be attachable to the rear cover and a second rear part of the second coupling mechanism may be attachable to the spine. Further, the first rear part may be coupled with the second rear part in a second attached state. Further, the digicational smart book may include an input device configured to receive a request from at least one user. Further, the digicational smart book may include the spine detachably attachable to the front cover and the rear cover. Further, the spine allows at least one of the front cover and the rear cover to pivotally rotate around a vertical axis of the spine. Further, the spine may include a processing device communicatively coupled with the input device. Further, the processing device may be configured for processing the request. Further, the spine may include a storage device communicatively coupled with the processing device. Further, the storage device may be configured for retrieving the at least one educational module based on the processing of the request. Further, the spine may include a communication device communicatively coupled with each of the at least one front screen, the at least one rear screen, and the processing device. Further, the communication device may be configured for transmitting at least one educational module to at least one of the at least one front screen and the at least one rear screen. Further, the at least one front screen and the at least one rear screen may be configured for displaying the at least one education module. Further, the digicational smart book may include at least one power source configured to provide electrical energy to each of the at least one front screen, the at least one rear screen, the communication device, the processing device, and the storage device.

Further disclosed herein is a digicational smart book for facilitating providing education to a user, in accordance with some embodiments. Accordingly, the digicational smart book may include a front cover that may include at least one first receptacle for receiving at least one front screen. Further, the front cover may be detachably attachable to a spine on a left side of the spine using a first coupling mechanism. Further, a first front part of the first coupling mechanism may be attachable to the front cover and a second front part of the first coupling mechanism may be attachable to the spine. Further, the first front part may be coupled with the second front part in a first attached state. Further, the digicational smart book may include a rear cover that may include at least one second receptacle for receiving at least one rear screen. Further, the rear cover may be detachably attachable to the spine on a right side of the spine using a second coupling mechanism. Further, a first rear part of the second coupling mechanism may be attachable to the rear cover and a second rear part of the second coupling mechanism may be attachable to the spine. Further, the first rear part may be coupled with the second rear part in a second attached state. Further, the digicational smart book may include an input device configured to receive a request from at least one user. Further, the digicational smart book may include the spine detachably attachable to the front cover and the rear cover. Further, the spine allows at least one of the front cover and the rear cover to pivotally rotate around a vertical axis of the spine. Further, the spine may include a processing device communicatively coupled with the input device. Further, the processing device may be configured for processing the request. Further, the spine may include a storage device communicatively coupled with the processing device. Further, the storage device may be configured for retrieving at least one educational module based on the processing of the request. Further, the spine may include a communication device communicatively coupled with each of the at least one front screen, the at least one rear screen, and the processing device. Further, the communication device may be configured for transmitting the at least one educational module to at least one of the at least one front screen and the at least one rear screen. Further, the at least one front screen and the at least one rear screen may be configured for displaying the at least one education module. Further, the spine may include a keyboard projector device disposed on the spine. Further, the keyboard projector device may include an optical projector configured for projecting a keyboard on a surface. Further, the keyboard projector device may include an optical receiver configured for generating reflection data based on receiving light reflected from the surface, wherein the processing device may be configured for analyzing the reflection data for generating a textual content. Further, the digicational smart book may include at least one power source configured to provide electrical energy to each of the at least one front screen, the at least one rear screen, the communication device, the processing device, and the storage device.

Further disclosed herein is a digicational smart book for facilitating providing education to a user, in accordance with some embodiments. Accordingly, the digicational smart book may include a front cover that may include at least one first receptacle for receiving at least one front screen. Further, the front cover may be detachably attachable to a spine on a left side of the spine using a first coupling mechanism. Further, a first front part of the first coupling mechanism may be attachable to the front cover and a second front part of the first coupling mechanism may be attachable to the spine. Further, the first front part may be coupled with the second front part in a first attached state. Further, the digicational smart book may include a rear cover that may include at least one second receptacle for receiving at least one rear screen. Further, the rear cover may be detachably attachable to the spine on a right side of the spine using a second coupling mechanism. Further, a first rear part of the second coupling mechanism may be attachable to the rear cover and a second rear part of the second coupling mechanism may be attachable to the spine. Further, the first rear part may be coupled with the second rear part in a second attached state. Further, the digicational smart book may include an input device configured to receive a request from at least one user. Further, the digicational smart book may include the spine detachably attachable to the front cover and the rear cover. Further, the spine allows at least one of the front cover and the rear cover to pivotally rotate around a vertical axis of the spine. Further, the spine may include a processing device communicatively coupled with the input device. Further, the processing device may be configured for processing the request. Further, the spine may include a storage device communicatively coupled with the processing device. Further, the storage device may be configured for retrieving at least one educational module based on the processing of the request. Further, the spine may include a communication device communicatively coupled with each of the at least one front screen, the at least one rear screen, and the processing device. Further, the communication device may be configured for transmitting the at least one educational module to at least one of the at least one front screen and the at least one rear screen. Further, the at least one front screen and the at least one rear screen may be configured for displaying the at least one education module. Further, the spine may include a keyboard projector device disposed on the spine. Further, the keyboard projector device may include an optical projector configured for projecting a keyboard on a surface. Further, the keyboard projector device may include an optical receiver configured for generating reflection data based on receiving light reflected from the surface. Further, the processing device may be configured for analyzing the reflection data for generating a textual content. Further, the digicational smart book may include at least one power source configured to provide electrical energy to each of the at least one front screen, the at least one rear screen, the communication device, the processing device, and the storage device. Further, the digicational smart book may include at least one solar panel configured for generating electrical power using solar energy. Further, the at least one solar panel may be disposed on the digicational smart book. Further, the at least one solar panel may be electrically coupled with the at least one power source. Further, the at least one power source may be configured to be recharged using the electrical energy.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a digicational smart book for facilitating providing education to a user, in accordance with some embodiments.

FIG. 2 is a front view of a digicational smart book for facilitating providing education to a user, in accordance with some embodiments.

FIG. 3 is a right-side view of the digicational smart book for facilitating providing education to a user, in accordance with some embodiments.

FIG. 4 is a front view of a digicational smart book for facilitating providing education to a user, in accordance with some embodiments.

FIG. 5 is a front view of a digicational smart book for facilitating providing education to a user, in accordance with some embodiments.

FIG. 6 is a front view of a digicational smart book for facilitating providing education to a user, in accordance with some embodiments.

FIG. 7 is a schematic of a system for facilitating providing education to a user, in accordance with some embodiments.

FIG. 8 is a front top right side perspective view of a digicational smart book for facilitating providing education to a user in an open configuration, in accordance with some embodiments.

FIG. 9 is a rear top left side perspective view of the digicational smart book for facilitating providing education to the user in the open configuration, in accordance with some embodiments.

FIG. 10 is a front view of the digicational smart book for facilitating providing education to the user in the open configuration, in accordance with some embodiments.

FIG. 11 is a rear view of the digicational smart book for facilitating providing education to the user in the open configuration, in accordance with some embodiments.

FIG. 12 is a right-side view of the digicational smart book for facilitating providing education to the user in the open configuration, in accordance with some embodiments.

FIG. 13 is a bottom view of the digicational smart book for facilitating providing education to the user in the open configuration, in accordance with some embodiments.

FIG. 14 is a front top left side perspective view of the digicational smart book for facilitating providing education to the user in the open configuration, in accordance with some embodiments.

FIG. 15 is a front top right side perspective view of the digicational smart book for facilitating providing education to the user in a closed configuration, in accordance with some embodiments.

FIG. 16 is a front view of the digicational smart book for facilitating providing education to the user in the closed configuration, in accordance with some embodiments.

FIG. 17 is a right-side view of the digicational smart book for facilitating providing education to the user in the closed configuration, in accordance with some embodiments.

FIG. 18 is a left-side view of the digicational smart book for facilitating providing education to the user in the closed configuration, in accordance with some embodiments.

FIG. 19 is a bottom view of the digicational smart book for facilitating providing education to the user in the closed configuration, in accordance with some embodiments.

FIG. 20 is an illustration of an online platform consistent with various embodiments of the present disclosure.

FIG. 21 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating providing education to a user, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating providing education to a user. Further, the disclosed device may include a Digicational Smart book (DB) for replacing premised based learning (schools, colleges, universities, etc.), and convention methods of teaching and instruction with a folding digicational learning center comprised of multiple mini-computers combined to deliver 4 separate interactive windows that deliver the following learning opportunities through the Digicational Smart book using a Wi-Fi connection. Further, the digicational smart book may enhance the quality of education. The digicational smart book may be an interactive tablet-like device with multiple screens. Further, the digicational smart book may provide a foldable tablet-like device that may mimic the structure of a textbook/folder. Further, the digicational smart book may include foldable and auto-resizing screens.

The digicational smart book may be the only book students may need from 7th grade through college as the learning experience and content are all digital and can be facilitated in a physical classroom setting or virtually anywhere. Further, the digicational smart book may include a digicam. Further, the digicational smart book may have camera-video conferencing capabilities (Teacher Conference, Counseling, Tutoring, Interaction with AI Robot). Further, the digicational smart book may be Bluetooth Enabled for Bluetooth pairing with all smart devices (watch, TV, phone, appliance, s and vehicles) for reminder notifications of tasks, tests, due dates, etc. Further, the digicational smart book may include a laser projected keyboard, 3 USB Ports, extendable integrated solar charging panel and standard plug, and individual mini-fans to circulate air and reduce temps. Further, digital lesson plans & lessons are created and delivered to individual or group digicational smart books (DSBs). Further, the digicational smart book may provide digital activities & exercises in lieu of normal on-prem-based teaching. Further, the digicational smart book may include downloadable audiobooks, downloadable homework & tests. Further, the digicational smart book may be associated with Digi-Net®. Further, the digicational smart book may include built-in controlled Wi-Fi and built-in translator, built-in calculator, built-in notepad, built-in audio jack for headphones, plugin ready, subscription-based content, customizable external book skins, and library link (Public, Univ., Gov.).

Further, the digicational smart book may provide restricted web access by URL. Further, the digicational smart book may provide Smart book managed Student Interactions. Further, the digicational smart book may connect to a library and open Digi-Browser [SEARCH]. Further, the digicational smart book may facilitate reading. Further, the digicational smart book may be associated with digital books and audiobooks. Further, the digicational smart book may be used for writing. Further, the digicational smart book may allow a student to learn languages, History & Government, Math, Statistics, Economics, and Sciences. Further, the digicational smart book may provide support requests such as teacher conferences, counseling, tutoring, and connecting with ‘Bert’. Further, the digicational smart book may provide class schedules and homework assignments. Further, the digicational Smart book may provide Simulation Exercises and Activities such as gaming, role-playing, decision making, debating, conflict, ai & robotics, and app builder. Further, the digicational smart book may be associated with subscription plug-ins for content purchases, windows & MAC, approved books, music, and video.

Further, the Digicational Smart book operates the same way standard desktop and Laptop computers work but utilizes a digital bus along integrated circuit boards and computers to allow the user/student to engage in educational learning experiences from any of the 4 windows. Further, the digicational smart book may include 4 mini-computers integrated through a digital bus command console, mini-fans for cooling and air circulation, laser project keyboard, earphone plug, wi-fi & ethernet jack IDE/ATA cables, Bluetooth, USB ports, computer processor chips, circuit boards, extendable integrated solar charging panel, rechargeable solar batteries, expandable memory port, outlet power cord, high-speed graphic accelerator cards, 7 TB memory storage, and magnesium-based alloy frame for snap-in replaceable scratch-proof monitors. Further, the components of the Digicational Smart book may be assembled much like a standard laptop. Further, the digicational smart book may include a power-on button to turn on all four computers and produce preset landing pages. Further, the student (or user) may select the functions they want to view and/or interact with on each screen and then select the function they want to use.

Further, in some embodiments, the digicational smart book may be used for today's Digicational Activities such as simulation training, playing analytical thinking games, and writing a 3-page paper. Further, the digicational smart book may connect to Library, open a Browser, and perform a digital search. Further, the digicational smart book may facilitate reading digital books and audiobooks. Further, the digicational smart book may be associated with the suggested reading of digital books and audiobooks. Further, the digicational smart book may facilitate creative writing. Further, the digicational smart book may be associated with school social media sites and school text messenger. Further, the digicational smart book may include downloadable lessons, downloadable reading content, downloadable activities, exercises, downloadable homework, assignments, downloadable practice tests, and smart book skins with school logos.

Further, the digicational smart book may be configured to be connected to a virtual robot tutor ‘BERT’. Further, the Bert may be maintained, supported, and updated by local college and university Robotics Students. The information captured by Bert during the tutoring sessions may be used by School Boards to determine opportunities for additional content development and delivery via Smart books, as well as local College University Departments of Education for student-teacher development.

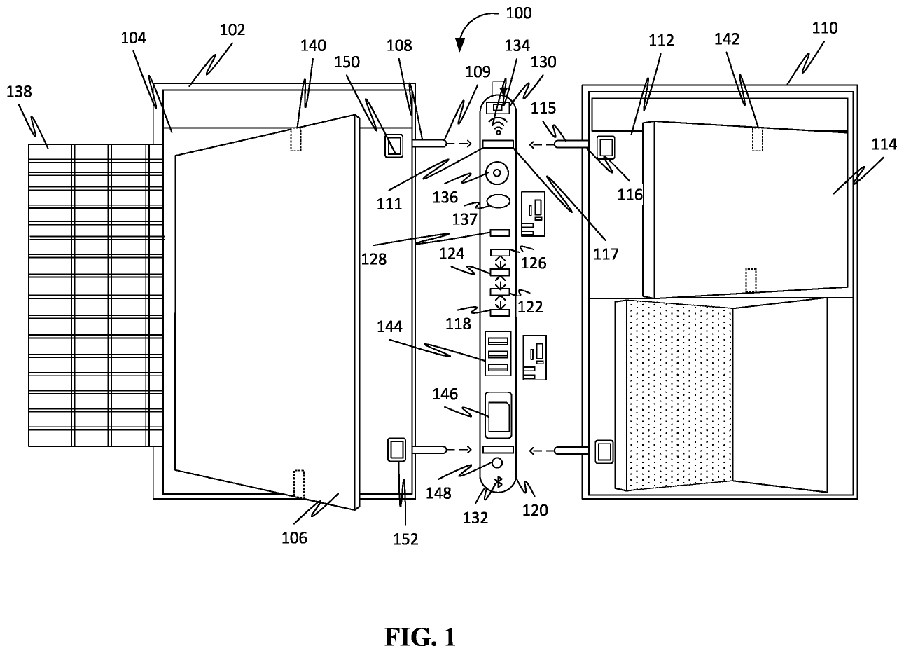

Referring now to figures, FIG. 1 is a front view of a digicational smart book 100 for facilitating providing education to a user, in accordance with some embodiments. Accordingly, the digicational smart book 100 may include a front cover 102 that may include at least one first receptacle 104 for receiving at least one front screen 106. Further, the front cover 102 may be detachably attachable to a spine 120 on a left side of the spine 120 using a first coupling mechanism 108. Further, a first front part 109 of the first coupling mechanism 108 may be attachable to the front cover 102 and a second front part 111 of the first coupling mechanism 108 may be attachable to the spine 120. Further, the first front part 109 may be coupled with the second front part 111 in a first attached state. Further, the first coupling mechanism 108 may include a hinge. Further, the front cover 102 may be attached to the spine 120 in the first attached state.

Further, the digicational smart book 100 may include a rear cover 110 that may include at least one second receptacle 112 for receiving at least one rear screen 114. Further, the rear cover 110 may be detachably attachable to the spine 120 on a right side of the spine 120 using a second coupling mechanism 116. Further, a first rear part 115 of the second coupling mechanism 116 may be attachable to the rear cover 110 and a second rear part 117 of the second coupling mechanism 116 may be attachable to the spine 120. Further, the first rear part 115 may be coupled with the second rear part 117 in a second attached state. Further, the second coupling mechanism 116 may include a hinge. Further, the rear cover 110 may be attached to the spine 120 in the second attached state.

Further, the digicational smart book 100 may include an input device 118 configured to receive a request from at least one user. Further, the input device 118 may include at least one of the at least one front screen 106, the at least one rear screen 114, and a user device. Further, the user device may include a smartphone, a tablet, a laptop, a computer, and so on.

Further, the digicational smart book 100 may include the spine 120 detachably attachable to the front cover 102 and the rear cover 110. Further, the spine 120 allows at least one of the front cover 102 and the rear cover 110 to pivotally rotate around a vertical axis of the spine 120. Further, the spine 120 may include a processing device 122 communicatively coupled with the input device 118. Further, the processing device 122 may be configured for processing the request. Further, the spine 120 may include a storage device 124 communicatively coupled with the processing device 122. Further, the storage device 124 may be configured for retrieving the at least one educational module based on the processing of the request. Further, the spine 120 may include a communication device 126 communicatively coupled with each of the at least one front screen 106, the at least one rear screen 114, and the processing device 122. Further, the communication device 126 may be configured for transmitting at least one educational module to at least one of the at least one front screen 106 and the at least one rear screen 114. Further, the at least one front screen 106 and the at least one rear screen 114 may be configured for displaying the at least one education module.

Further, the digicational smart book 100 may include at least one power source 128 configured to provide electrical energy to each of the at least one front screen 106, the at least one rear screen 114, the communication device 126, the processing device 122, and the storage device 124.

Further, in some embodiments, the spine 120 may include a keyboard projector device 130 disposed on the spine 120. Further, the keyboard projector device 130 may include an optical projector configured for projecting a keyboard on a surface. Further, the keyboard projector device 130 may include an optical receiver configured for generating reflection data based on receiving light reflected from the surface. Further, the processing device 122 may be configured for analyzing the reflection data for generating a textual content.

Further, in some embodiments, the spine 120 may include at least one bluetooth indicator 132 disposed on the spine 120. Further, the at least one bluetooth indicator 132 may be communicatively coupled to the processing device 122. Further, the at least one bluetooth indicator 132 may be configured for visually indicating a connectivity status of at least one external Bluetooth device with the digicational smart book 100. Further, the communication device 126 may include a Bluetooth transceiver. Further, the processing device 122 may be configured for determining the connectivity status.

Further, in some embodiments, the spine 120 may include at least one Wi-Fi indicator 134 disposed on the spine 120. Further, the at least one Wi-Fi indicator 134 may be communicatively coupled to the processing device 122. Further, the at least one Wi-Fi indicator 134 may be configured for visually indicating a network connectivity status of the digicational smart book 100 with at least one Wi-Fi network. Further, the communication device 126 may include a Wi-Fi transceiver. Further, the processing device 122 may be configured for determining the network connectivity status.

Further, in some embodiments, the digicational smart book 100 may include a power on/off button 137 to turn the digicational smart book 100 on and off.

Further, in some embodiments, the spine 120 may include at least one image sensor 136 communicatively coupled with the processing device 122. Further, the at least one image sensor 136 may be configured for generating at least one image data. Further, the processing device 122 may be configured for analyzing the at least one image data and generating at least one digital content based on the analyzing of the at least one image data. Further, the communication device 126 may be configured for transmitting the at least one digital content to at least one of the at least one front screen 106 and the at least one rear screen 114.

In further embodiments, the digicational smart book 100 may include at least one solar panel 138 configured for generating electrical power using solar energy. Further, the at least one solar panel 138 may be disposed on the digicational smart book 100. Further, the at least one solar panel 138 may be ejected parallel to a surface of the front cover 102 using an ejection mechanism. Further, the ejection mechanism may be configured for transitioning between an extended state and a retracted state. Further, the at least one solar panel 138 may be ejected out of a panel receptacle comprised in the front cover 102 in the extended state and hidden inside the panel receptacle in the retracted state. Further, the panel receptacle may be configured for accommodating the at least one solar panel 138. Further, the at least one solar panel 138 may be electrically coupled with the at least one power source 128. Further, the at least one power source 128 may be configured to be recharged using the electrical power.

Further, in some embodiments, the at least one front screen 106 may be pivotally coupled to the front cover 102 using at least one first flipping mechanism 140. Further, the at least one first flipping mechanism 140 may be configured for rotating the at least one front screen 106 around an axis. Further, the at least one first flipping part of the at least one first flipping mechanism 140 may be disposed on a periphery of one of the front cover 102. Further, at least one second flipping part of the at least one first flipping mechanism 140 may be disposed on a rear surface of the front cover 102. Further, the at least one second flipping part comprises a receptacle for receiving the at least one first flipping part, wherein the at least one first flipping part is configured for rotating around the axis inside the at least one second flipping part, wherein the rotating of the at least one first flipping part rotates the at least one front screen 106.

Further, in some embodiments, the at least one rear screen 114 may be pivotally coupled to the rear cover 110 using at least one second flipping mechanism 142. Further, the at least one second flipping mechanism 142 may be configured for rotating the at least one rear screen 114 around an axis.

Further, in some embodiments, the spine 120 may include a plurality of ports 144-148 communicatively coupled with the processing device 122. Further, the plurality of ports 144-148 may include audio ports, microphone ports, audio line-in ports, audio line-out ports, USB ports, and memory card ports. Further, the USB ports may be the section of the spine 120 that establishes specifications for cables and connectors and protocols for connection, communication, and power supply between computers, peripherals, and other computers. The USB ports may be rectangular insertion ports located on the front face of the spine 120. More specifically, the USB ports may be positioned on the lower front section of the spine 120. Further, the memory card ports may be the section of the spine 120 that establishes specifications for external memory cards. Memory cards include, but are not limited to, secure digital (SD) cards, micro-SD cards, etc. The memory card ports may be flat rectangular insertion ports located on the front face of the spine 120. More specifically, the memory card ports may be positioned on the lower section of the spine 120.

Further, in some embodiments, the digicational smart book 100 may include computer processor chips 150-152.

Further, in some embodiments, the at least one digital content may include a photo of a user that may want to use the digicational smart book 100. Further, the storage device 124 may be configured for retrieving verified identity data. Further, the verified identity data may include facial characteristics of verified users that may be verified to use the digicational smart book 100. Further, the processing device 122 may be configured for analyzing the at least one digital content and the verified identity data. Further, the processing device 122 may be configured for generating an access command based on the analyzing of the at least one digital content and the verified identity data. Further, the transmitting of the at least one education module may be based on the access command. Further, the processing device 122 may be configured for one of allowing or restricting the user to use the digicational smart book 100 based on the access command.

Further, in some embodiments, the digicational smart book 100 may include a locking mechanism disposed on the digicational smart book 100. Further, the locking mechanism may be configured for transitioning the digicational smart book 100 between a locked (or closed) state and an open state based on an unlocking command. Further, the locking mechanism may include an electromagnetic locking mechanism. Further, in the locked state, the locking mechanism may prevent the front cover 102 to be separated from the rear cover 110. Further, in the locked state, a distal edge of the front cover 102 may be in physical contact with a distal edge of the rear cover 110. Further, in the open state, the locking mechanism may allow the distal edge of the front cover 102 to be separated from the distal edge of the rear cover 110 to open the digicational smart book 100. Further, the locking mechanism may be communicatively coupled with the processing device 122. Further, the communication device 126 may be configured for receiving at least one sensor data from at least one sensor disposed on the digicational smart book 100. Further, the at least one sensor may be configured for generating the at least one sensor data based on detecting at least one identifying characteristic of a user. Further, the at least one sensor may include a biometric sensor, an audio sensor, etc. Further, the at least one sensor may include a fingerprint sensor disposed on an external surface of the digicational smart book 100. Further, the processing device 122 may be configured for processing the at least one sensor data and the verified identity data for generating the unlocking command. Further, the communication device 126 may be configured for transmitting the unlocking command to the locking mechanism. Further, the generating of the access command may be based on the analyzing of the at least one sensor data and the verified identity data.

Further, in some embodiments, the unlocking command may include a malicious command that may reflect an undesirable attempt to open the digicational smart book 100 by an unauthorized person. Further, the processing device 122 may be configured for generating an alarm based on the malicious command. Further, the communication device 126 may be configured for transmitting the alarm to at least one user device associated with the verified user. Further, the storage device 124 may be configured for storing the at least one sensor data, the unlocking command, and the access command. Further, the the at least one user device may include a smartphone, a tablet, a laptop, etc.

Further, in some embodiments, the at least one sensor may include a motion sensor, impact sensor, thermal sensor, force sensor, etc. Further, the processing device 122 may be configured for analyzing the at least one sensor data for determining at least one physical characteristic of the digicational smart book 100. Further, the at least one physical characteristic may include an orientation, a force being applied on the digicational smart book 100, a temperature, etc. Further, the processing device 122 may be configured for analyzing the at least one physical characteristic using a machine learning algorithm. Further, the processing device 122 may be configured for generating a damage alarm based on the analyzing of the physical motion characteristic of the digicational smart book 100. Further, the damage alarm may notify the verified user that an individual may be trying to damage or destroy the digicational smart book 100. Further, the communication device 126 may be configured for transmitting the alarm to the at least one user device.

Further, in some embodiments, the digicational smart book 100 may be coated with a liquid-resistant coating. Further, the liquid-resistant coating may include an adhesive. Further, the liquid-resistant coating may protect the digicational smart book 100 against damage from a liquid such as water.

Further, in some embodiments, the digicational smart book 100 may include a dust repellant coating that may prevent dust or dirt from settling on the digicational smart book 100.

Further, in some embodiments, the digicational smart book 100 may include at least one customizable exterior surface for at least one of the front cover 102 and the rear cover 110. Further, the at least one customizable exterior surface may include one or more of fabric, leather, canvas, or acrylic.

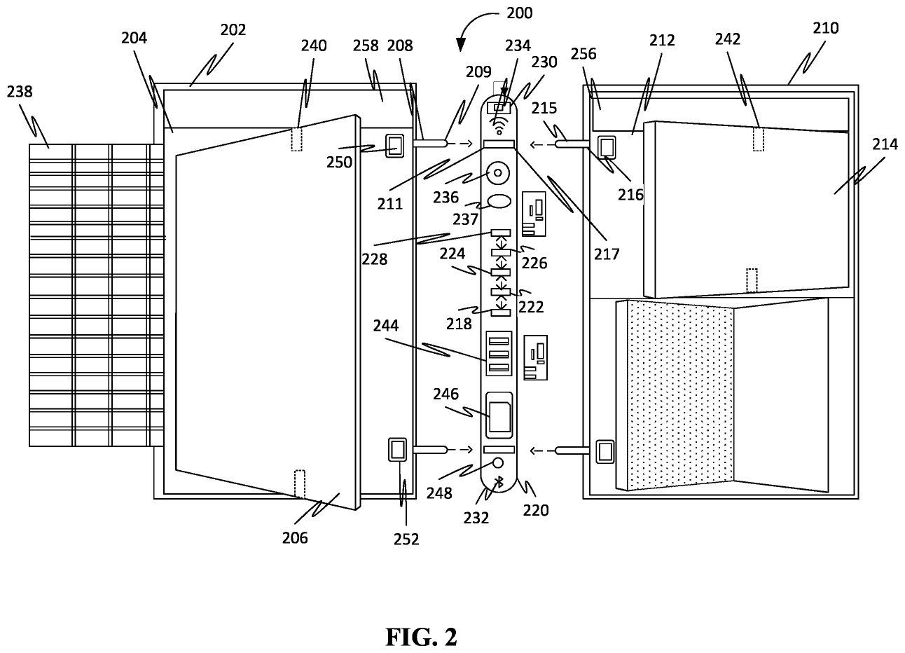

FIG. 2 is a front view of a digicational smart book 200 for facilitating providing education to a user, in accordance with some embodiments. Accordingly, the digicational smart book 200 may include a front cover 202 that may include at least one first receptacle 204 for receiving at least one front screen 206. Further, the front cover 202 may be detachably attachable to a spine 220 on a left side of the spine 220 using a first coupling mechanism 208. Further, a first front part 209 of the first coupling mechanism 208 may be attachable to the front cover 202 and a second front part 211 of the first coupling mechanism 208 may be attachable to the spine 220. Further, the first front part 209 may be coupled with the second front part 211 in a first attached state.

Further, the digicational smart book 200 may include a rear cover 210 that may include at least one second receptacle 212 for receiving at least one rear screen 214. Further, the rear cover 210 may be detachably attachable to the spine 220 on a right side of the spine 220 using a second coupling mechanism 216. Further, a first rear part 215 of the second coupling mechanism 216 may be attachable to the rear cover 210 and a second rear part 217 of the second coupling mechanism 216 may be attachable to the spine 220. Further, the first rear part 215 may be coupled with the second rear part 217 in a second attached state.

Further, the digicational smart book 200 may include an input device 218 configured to receive a request from at least one user.

Further, the digicational smart book 200 may include the spine 220 detachably attachable to the front cover 202 and the rear cover 210. Further, the spine 220 allows at least one of the front cover 202 and the rear cover 210 to pivotally rotate around a vertical axis of the spine 220. Further, the spine 220 may include a processing device 222 communicatively coupled with the input device 218. Further, the processing device 222 may be configured for processing the request. Further, the spine 220 may include a storage device 224 communicatively coupled with the processing device 222. Further, the storage device 224 may be configured for retrieving the at least one educational module based on the processing of the request. Further, the spine 220 may include a communication device 226 communicatively coupled with each of the at least one front screen 206, the at least one rear screen 214 and the processing device 222. Further, the communication device 226 may be configured for transmitting at least one educational module to at least one of the at least one front screen 206 and the at least one rear screen 214. Further, the at least one front screen 206 and the at least one rear screen 214 may be configured for displaying the at least one education module. Further, the spine 220 may include a keyboard projector device 230 disposed on the spine 220. Further, the keyboard projector device 230 may include an optical projector configured for projecting a keyboard on a surface. Further, the keyboard projector device 230 may include an optical receiver configured for generating reflection data based on receiving light reflected from the surface. Further, the processing device 222 may be configured for analyzing the reflection data for generating a textual content.

Further, the digicational smart book 200 may include at least one power source 228 configured to provide electrical energy to each of the at least one front screen 206, the at least one rear screen 214, the communication device 226, the processing device 222, and the storage device 224.

Further, in some embodiments, the spine 220 may include at least one bluetooth indicator 232 disposed on the spine 220. Further, the at least one bluetooth indicator 232 may be communicatively coupled to the processing device 222. Further, the at least one bluetooth indicator 232 may be configured for visually indicating a connectivity status of at least one external Bluetooth device with the digicational smart book 200. Further, the communication device 226 may include a Bluetooth transceiver. Further, the processing device 222 may be configured for determining the connectivity status.

Further, in some embodiments, the spine 220 may include at least one Wi-Fi indicator 234 disposed on the spine 220.

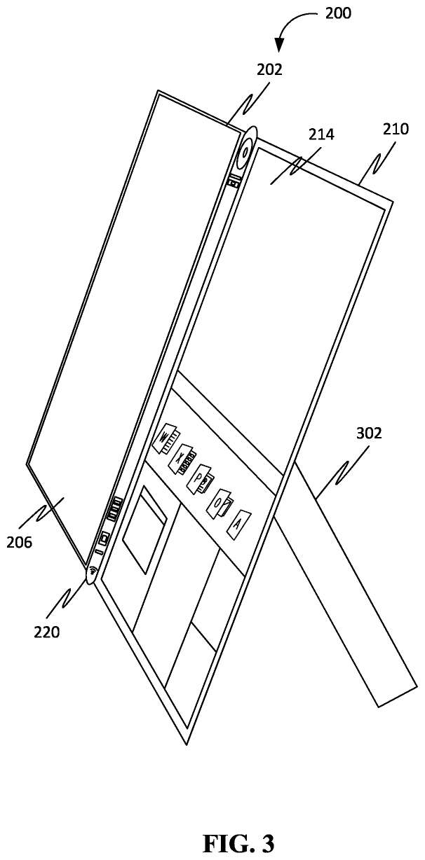

In further embodiments, the digicational smart book 200 may include at least one stand 302 (as shown in FIG. 3) attachable to a rear surface of the digicational smart book 200. Further, the at least one stand 302 may be configured to releasably retain the digicational smart book 200 at an angle with the surface.

In further embodiments, the digicational smart book 200 may include a plurality of individual mini-fans 256-258 disposed on the digicational smart book 200. Further, the plurality of individual mini-fans 256-258 may be electrically coupled with the at least one power source 228. Further, the plurality of individual mini-fans 256-258 may be configured to circulate air and reduce a temperature of a surrounding of the digicational smart book 200.

Further, in some embodiments, the digicational smart book 200 may include a power on/off button 237 to turn the digicational smart book 200 on and off.

Further, in some embodiments, the spine 220 may include an image sensor 236.

In further embodiments, the digicational smart book 200 may include at least one solar panel 238 configured for generating electrical power using solar energy. Further, the at least one solar panel 238 may be disposed on the digicational smart book 200. Further, the at least one solar panel 238 may be electrically coupled with the at least one power source 228. Further, the at least one power source 228 may be configured to be recharged using the electrical power.

Further, in some embodiments, the at least one front screen 206 may be pivotally coupled to the front cover 202 using at least one first flipping mechanism 240. Further, the at least one first flipping mechanism 240 may be configured for rotating the at least one front screen 206 around an axis.

Further, in some embodiments, the at least one rear screen 214 may be pivotally coupled to the rear cover 210 using at least one second flipping mechanism 242. Further, the at least one second flipping mechanism 242 may be configured for rotating the at least one rear screen 214 around an axis.

Further, in some embodiments, the spine 220 may include a plurality of ports 244-248 communicatively coupled with the processing device 222. Further, the plurality of ports 244-248 may include audio ports, microphone ports, audio line-in ports, audio line-out ports, USB ports, and memory card ports.

Further, in some embodiments, the digicational smart book 200 may include computer processor chips 250-252.

FIG. 3 is a right-side view of the digicational smart book 200 for facilitating providing education to a user, in accordance with some embodiments.

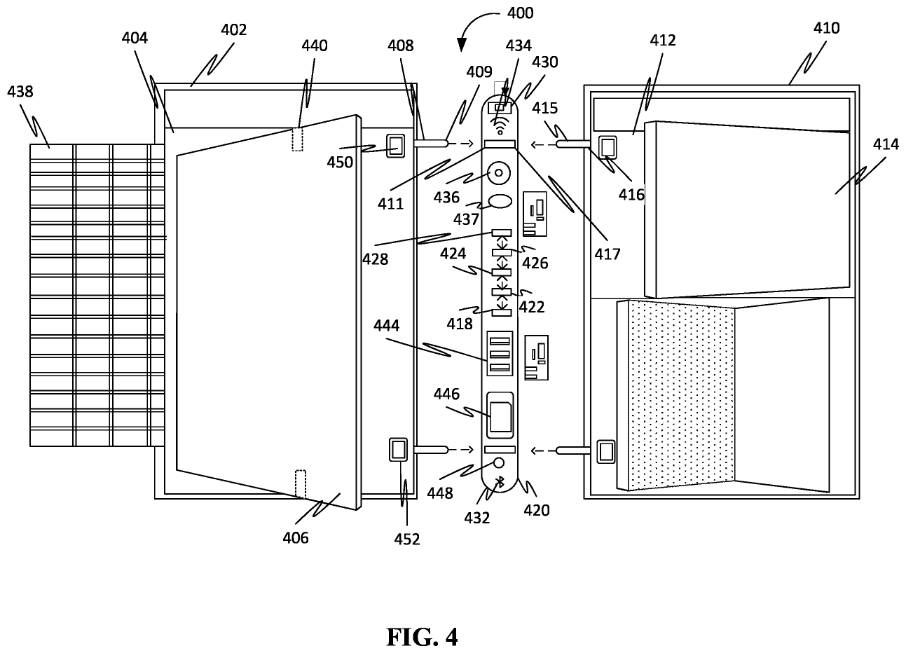

FIG. 4 is a front view of a digicational smart book 400 for facilitating providing education to a user, in accordance with some embodiments. Accordingly, the digicational smart book 400 may include a front cover 402 that may include at least one first receptacle 404 for receiving at least one front screen 406. Further, the front cover 402 may be detachably attachable to a spine 420 on a left side of the spine 420 using a first coupling mechanism 408. Further, a first front part 409 of the first coupling mechanism 408 may be attachable to the front cover 402 and a second front part 411 of the first coupling mechanism 408 may be attachable to the spine 420. Further, the first front part 409 may be coupled with the second front part 411 in a first attached state.

Further, the digicational smart book 400 may include a rear cover 410 that may include at least one second receptacle 412 for receiving at least one rear screen 414. Further, the rear cover 410 may be detachably attachable to the spine 420 on a right side of the spine 420 using a second coupling mechanism 416. Further, a first rear part 415 of the second coupling mechanism 416 may be attachable to the rear cover 410 and a second rear part 417 of the second coupling mechanism 416 may be attachable to the spine 420. Further, the first rear part 415 may be coupled with the second rear part 417 in a second attached state.

Further, the digicational smart book 400 may include an input device 418 configured to receive a request from at least one user.

Further, the digicational smart book 400 may include the spine 420 detachably attachable to the front cover 402 and the rear cover 410. Further, the spine 420 allows at least one of the front cover 402 and the rear cover 410 to pivotally rotate around a vertical axis of the spine 420. Further, the spine 420 may include a processing device 422 communicatively coupled with the input device 418. Further, the processing device 422 may be configured for processing the request. Further, the spine 420 may include a storage device 424 communicatively coupled with the processing device 422. Further, the storage device 424 may be configured for retrieving the at least one educational module based on the processing of the request. Further, the spine 420 may include a communication device 426 communicatively coupled with each of the at least one front screen 406, the at least one rear screen 414 and the processing device 422. Further, the communication device 426 may be configured for transmitting at least one educational module to at least one of the at least one front screen 406 and the at least one rear screen 414. Further, the at least one front screen 406 and the at least one rear screen 414 may be configured for displaying the at least one education module. Further, the spine 420 may include a keyboard projector device 430 disposed on the spine 420. Further, the keyboard projector device 430 may include an optical projector configured for projecting a keyboard on a surface. Further, the keyboard projector device 430 may include an optical receiver configured for generating reflection data based on receiving light reflected from the surface. Further, the processing device 422 may be configured for analyzing the reflection data for generating a textual content.

Further, the digicational smart book 400 may include at least one power source 428 configured to provide electrical energy to each of the at least one front screen 406, the at least one rear screen 414, the communication device 426, the processing device 422, and the storage device 424.

Further, the digicational smart book 400 may include at least one solar panel 438 configured for generating electrical power using solar energy. Further, the at least one solar panel 438 may be disposed on the digicational smart book 400. Further, the at least one solar panel 438 may be electrically coupled with the at least one power source 428. Further, the at least one power source 428 may be configured to be recharged using the electrical power.

Further, in some embodiments, the digicational smart book 400 may include a power on/off button 437 to turn the digicational smart book 400 on and off.

Further, in some embodiments, the spine 420 may include at least one image sensor 436 communicatively coupled with the processing device 422. Further, the at least one image sensor 436 may be configured for generating at least one image data.

Further, in some embodiments, the at least one front screen 406 may be pivotally coupled to the front cover 402 using at least one first flipping mechanism 440. Further, the at least one first flipping mechanism 440 may be configured for rotating the at least one front screen 406 around an axis.

Further, in some embodiments, the digicational smart book 400 may include a Bluetooth indicator 432, a wifi indicator 434, a plurality of ports 444-448, and computer processor chips 450-452.

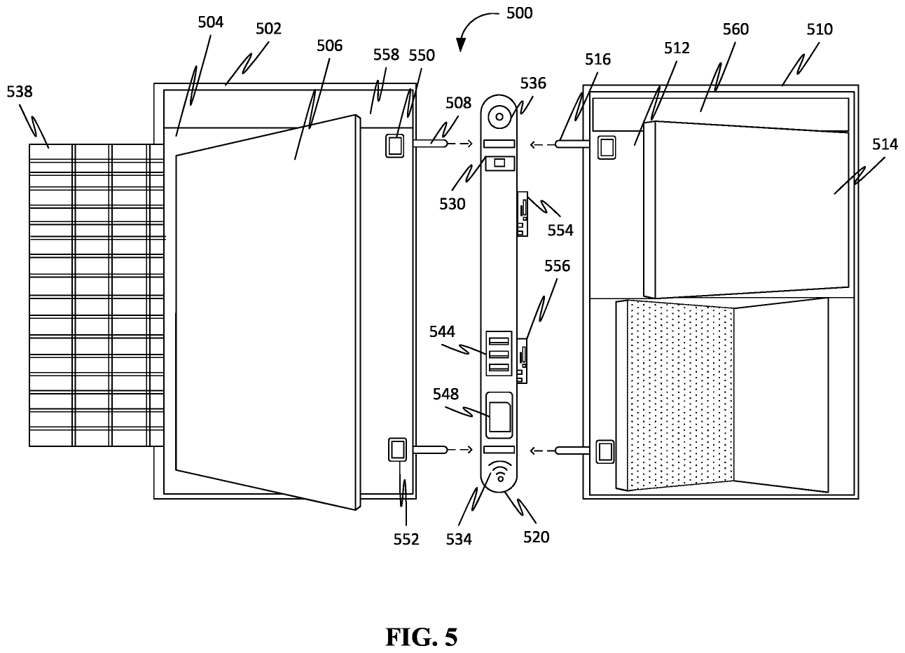

FIG. 5 is a front view of a digicational smart book 500 for facilitating providing education to a user, in accordance with some embodiments. Accordingly, the digital smart book 500 may include a front cover 502 that may include at least one first receptacle 504 for receiving at least one front screen 506. Further, the front cover 502 may be detachably attachable to a spine 520 on a left side of the spine 520 using a first coupling mechanism 508. Further, the digicational smart book 500 may include a rear cover 510 that may include at least one second receptacle 512 for receiving at least one rear screen 514. Further, the rear cover 510 may be detachably attachable to the spine 520 on a right side of the spine 520 using a second coupling mechanism 516. Further, the digicational smart book 500 may include the spine 520 detachably attachable to the front cover 502 and the rear cover 510. Further, the spine 520 allows at least one of the front cover 502 and the rear cover 510 to pivotally rotate around a vertical axis of the spine 520. Further, the spine 520 may include a keyboard projector device 530 disposed on the spine 520. Further, the keyboard projector device 530 may be configured for projecting a keyboard on a surface. Further, the spine 520 may include at least one Wi-Fi indicator 534 disposed on the spine 520. Further, the at least one Wi-Fi indicator 534 may be configured for visually indicating a network connectivity status of the digicational smart book 500 with at least one Wi-Fi network. Further, the spine 520 may include a camera 536. Further, the digicational smart book 500 may include at least one solar panel 538 configured for generating electrical power using solar energy. Further, the spine 520 may include a plurality of ports (544 and 548). Further, the plurality of ports (544 and 548) may include audio ports, microphone ports, audio line-in ports, audio line-out ports, USB ports, and memory card ports. Further, the digicational smart book 500 may include computer processor chips 550-552. Further, the digicational smart book 500 may include integrated circuit boards 554-556. Further, the digicational smart book 500 may include mini fans 558-560.

Further, the digicational smart book 500 may be a detachable/replaceable communications center. Further, the digicational smart book 500 may include a detachable/replaceable computer monitor with a fast graphics accelerator card. Further, the digicational smart book 500 may include a detachable/replaceable computer & technology bus. Further, the digicational smart book 500 may include a second detachable/replaceable computer monitor with a fast graphics accelerator card. Further, the digicational smart book 500 may be used for video conferencing. Further, the digicational smart book 500 may include a third detachable/replaceable computer monitor with a fast graphics accelerator card. Further, the digicational smart book 500 may include a green screen & emulator. Further, the digicational smart book 500 may include memory card slots. Further, the digicational smart book 500 may include an audio bar and an ear jack. Further, the digicational smart book 500 may include external digital skins for the front cover 502. Further, the digicational smart book 500 may be paired to a smartphone, a smartwatch, smart appliances, a smart TV, and an automobile using Bluetooth.

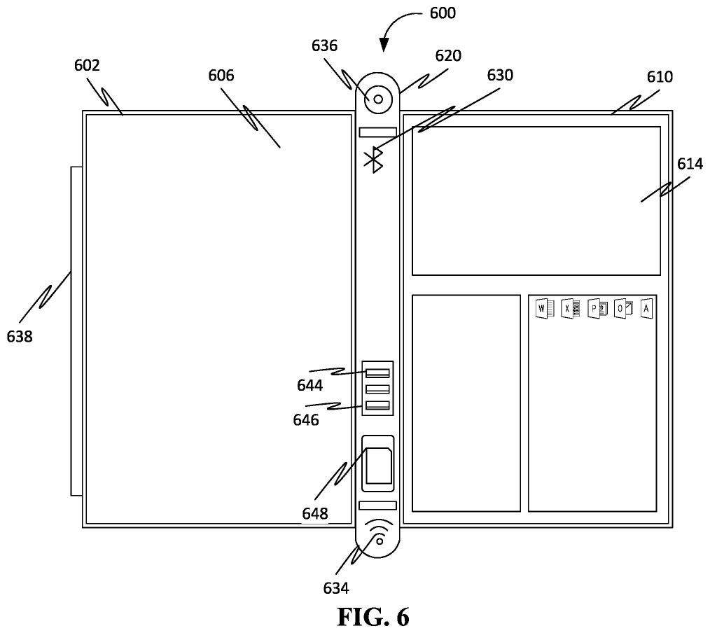

FIG. 6 is a front view of a digicational smart book 600 for facilitating providing education to a user, in accordance with some embodiments. Accordingly, the digital smart book 600 may include a front cover 602 configured for holding at least one front screen 606. Further, the front cover 602 may be detachably attachable to a spine 620 on a left side of the spine 620. Further, the digicational smart book 600 may include a rear cover 610 configured for holding at least one rear screen 614. Further, the rear cover 610 may be detachably attachable to the spine 620 on a right side of the spine 620. Further, the digicational smart book 600 may include the spine 620 detachably attachable to the front cover 602 and the rear cover 610. Further, the spine 620 allows at least one of the front cover 602 and the rear cover 610 to pivotally rotate around a vertical axis of the spine 620. Further, the spine 620 may include a Bluetooth indicator 630 disposed on the spine 620. Further, the bluetooth indicator 630 may be configured for visually indicating connectivity status of the digicational smart book 600 with at least one external Bluetooth device. Further, the spine 620 may include at least one Wi-Fi indicator 634 disposed on the spine 620. Further, the at least one Wi-Fi indicator 634 may be configured for visually indicating a network connectivity status of the digicational smart book 600 with at least one Wi-Fi network. Further, the spine 620 may include a camera 636. Further, the digicational smart book 600 may include at least one solar panel 638 configured for generating electrical power using solar energy. Further, the spine 620 may include a plurality of ports 644-648. Further, the plurality of ports 644-648 may include audio ports, microphone ports, audio line-in ports, audio line-out ports, USB ports, and memory card ports.

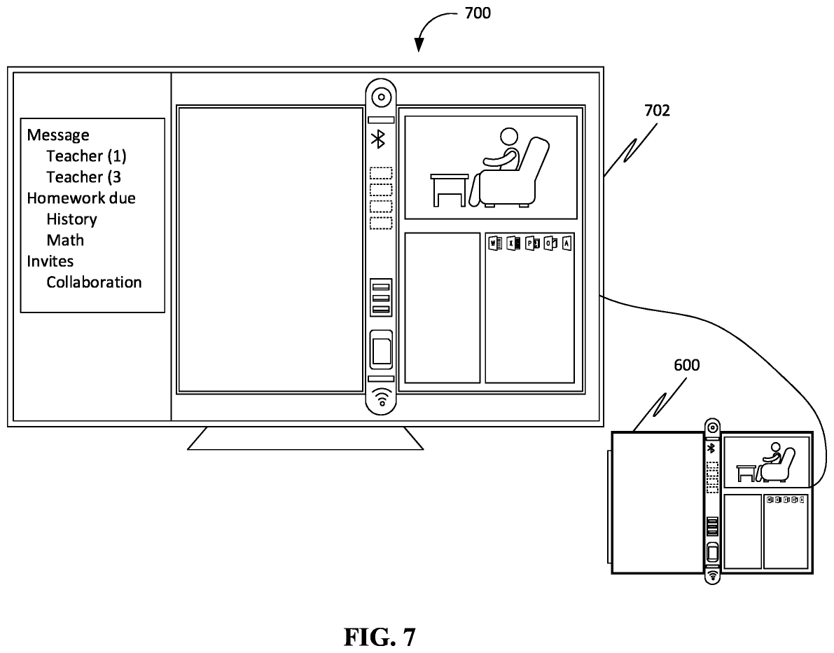

FIG. 7 is a schematic of a system 700 for facilitating providing education to a user, in accordance with some embodiments. Accordingly, the system 700 may include the digicational smart book 600 connected to a smart TV 702 using Bluetooth.

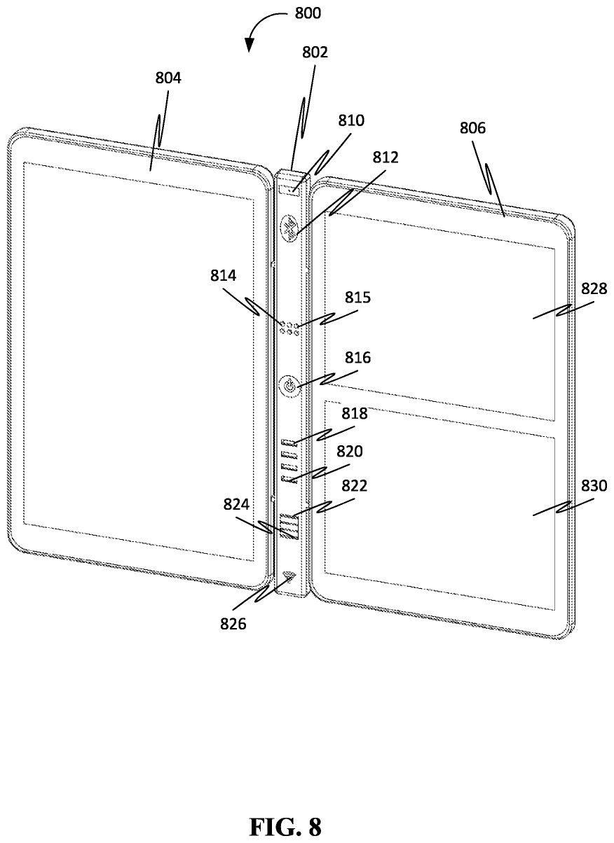

FIG. 8 is a front top right side perspective view of a digicational smart book 800 for facilitating providing education to a user in an open configuration, in accordance with some embodiments. Accordingly, the digicational smart book 800 replaces premised-based learning, such as in-person classes. Further, the digicational smart book 800 replaces conventional methods of teaching and instruction with a device comprising multiple display screens. The digicational smart book 800 uses Wi-Fi connectivity to gain access to the global computer network also known as the Internet. The Internet may provide a variety of information and communication facilities, consisting of interconnected networks using standardized communication protocols. Further, the digicational smart book 800 has access to textbooks of 7^{th} graded and onwards as the learning experience and content may be all digital and can be facilitated in a physical classroom setting or virtually anywhere.

The digicational smart book 800 may be a device that enhances the quality of education. Further, the digicational smart book 800 provides an interactive tablet-like device with multiple computers and display screens.

Further, the digicational smart book 800 may include a spine 802, a front cover 804, and a rear cover 806.

Further, the spine 802 may be the center connecting component of the front cover 804 and the rear cover 806. The spine 802 provides a wide range of features and functionality. More specifically, the digicational smart book 800 comprises a keyboard projector 810, a Bluetooth light 812, a set of jacks/ports 814-815, a power button 816, a set of universal serial bus (USB) ports 818-820, a set of memory card ports 822-824, a camera (not shown), and a Wi-Fi light 826.

The keyboard projector 810 may be a projectable keyboard built into the spine 802. The keyboard projector 810 may project a keyboard for the user. The projected keyboard by the keyboard projector 810 may be utilized as a standard keyboard. The keyboard projector 810 may be located on the front face of the spine 802. More specifically, the keyboard projector 810 may be positioned on the top front section of the spine 802. Further, the Bluetooth light 812 may be the light that indicates connectivity of external Bluetooth devices. The Bluetooth light 812 may be located on the front face of the spine 802. More specifically, the Bluetooth light 812 may be positioned on the top end of the spine 802. The Bluetooth light 812 may allow the user to confirm whether a Bluetooth device may be connected to the digicational smart book 800. Further, the set of jacks/ports 814-815 may be a plurality of jacks/ports of communication endpoint or sockets to receive jack plugs. Further, the set of jacks/ports 814-815 may be audio ports, microphone ports, audio line-in ports, audio line-out ports, etc. The set of jacks/ports 814-815 may not be limited to the aforementioned ports. Further, the power button 816 may be a round button that powers digicational smart book 800 on and off. The power button 816 may be located on the front face of the spine 802. More specifically, the power button 816 may be located towards the center front face of the spine 802. The power button 816 allows the user to turn on/off the digicational smart book 800 when desired. Further, the set of USB ports 818-820 may be disposed in the section of the spine 802 that establishes specifications for cables and connectors and protocols for connection, communication, and power supply between computers, peripherals, and other computers. The set of USB ports 818-820 may be rectangular insertion ports located on the front face of the spine 802. More specifically, the set of USB ports 818-820 may be positioned on the lower front section of the spine 802. Further, the set of memory card ports 822-824 may be the section of the spine 802 that establishes specifications for external memory cards. Memory cards include, but may not be limited to, secure digital (SD) cards, micro-SD cards, etc. The set of memory card ports 822-824 may be flat rectangular insertion ports located on the front face of the spine 802. More specifically, the set of memory card ports 822-824 may be positioned on the lower section of the spine 802. Further, the camera may be a digital video device that transmits visuals to the digicational smart book 800. More specifically, the camera may be an optical instrument of the digicational smart book 800 that captures visual images/videos for the digicational smart book 800. The camera may be located on the front face of the spine 802. The camera may be utilized to digitally display pictures and video calls of the content in front of the camera. In the preferred embodiment, the camera may be used for video conference calls or of the like. Further, the Wi-Fi light 826 may be the light that indicates a connectivity of Wi-Fi. The Wi-Fi light 826 may be located on the front face of the spine 802. More specifically, the Wi-Fi light 826 may be positioned on the bottom end of the spine 802. The Wi-Fi light 826 may allow the user to confirm whether the digicational smart book 800 may be connected to a Wi-Fi connection.

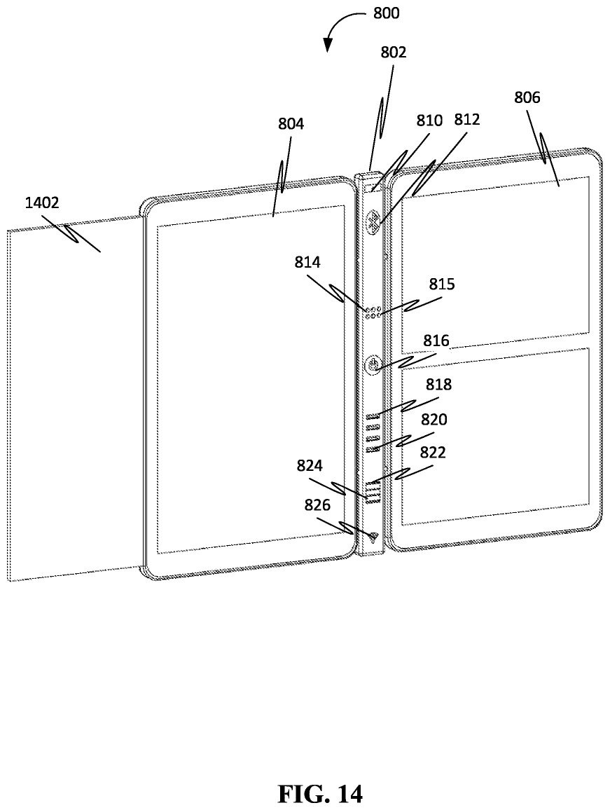

Further, the front cover 804 may be the largest display screen of the digicational smart book 800. The front cover 804 connects to the left side of the spine 802. The front cover 804 may be detachable from the spine 802. Within the interior side of the front cover 804, there may be a display screen that may provide a visual presentation screen for the computer of the front cover 804. The internal components of the front cover 804 may mimic the internal components of a standard computer, tablet, laptop, or the like. In addition, on the edge of the front cover 804, the digicational smart book 800 may include a solar panel 1402 (as shown in FIG. 14) that can be used. The solar panel 1402 may be located within the front cover 804 and ejects parallel to the surface of the front cover 804. The solar panel 1402 may allow the user to charge energy by means of the solar panels built into the front cover 804. The solar panel 1402 may be used for charging the internal battery, assisting the power usage alongside the internal battery of the digicational smart book 800, etc.

Further, the rear cover 806 may be the portion of the digicational smart book 800 that comprises of smaller display screens. The rear cover 806 connects to the right side of the spine 802. The rear cover 806 may be detachable from the spine 802. Within the interior side of the rear cover 806, there may be two sets of display screen that may provide a visual presentation screen for the computers of the rear cover 806. The rear cover 806 further comprises a top screen 828, a bottom screen 830, a top set of internal parts (not shown), and a bottom set of internal parts (not shown). The top screen 828 and the bottom screen 830 may be approximately half the size of the display screen of the front cover 804. The top screen 828 may be the top surface section of the interior side of the rear cover 806. The bottom screen 830 may be the bottom surface section of the interior side of the rear cover 806. The top set of internal parts and the bottom set of internal parts may mimic the internal components of a standard computer, tablet, laptop, or the like. The top set of internal parts connects with the top screen 828. The bottom set of internal parts connects with the bottom screen 830. The internal parts and the display screen work together similarly to a computer and a monitor, a tablet, or the like.

The digicational smart book 800 components may connect and operate together as a system. The Bluetooth technology of the digicational smart book 800 allows for the connection of external devices. The connectivity of Bluetooth may allow the user to receive alerts and reminders of smartphones, smartwatches, smart appliances, smart televisions (TV), automobiles, etc. Essentially, the Bluetooth connectivity may provide alerts and notifications of the connected external device. The connectivity of the digicational smart book 800 to the internet provides a wide range of functionality. The digicational smart book 800 may operate similarly to a computer, a tablet, or of the like. The digicational smart book 800 has features of a Digi-cam, camera, digital lessons & plans, digital activities & exercises, downloadable audiobooks, downloadable, downloadable homework & tests, Digi-net, restricted web access by URL, built-in translator, built-in calculator, built-in note pad, built-in audio jacks/ports for external devices, plugin ready, subscription-based content, customizable external book skins, library links, etc. The digicational smart book 800 essentially may operate similarly to a computer/tablet. Note that the front cover 804 and rear cover 806 may be detachable and may be able to attach on either side of the spine 802. Further, the front cover 804 may be attached on the left side of the spine 802 and the rear cover 806 may be attached on the right side of the spine 802.

Further, the digicational smart book 800 may be utilized as a device to create a virtual online class without the need to physically be at a particular location for attending a class. For instance, students of different locations around the world can participate in the same class such as people from Canada can participate in class one in Russia. Furthermore, the availability of multiple screens of the digicational smart book 800 allows the user to operate simultaneously as well as differently. More specifically, the user can use the display screen of the front cover 804 as a writing section, the top screen 828 of the rear cover 806 can be used as a webcam display of a classroom in which the student may be participating, and the bottom screen 830 of the rear cover 806 can be used as a textbook. Note that the aforementioned situation may be only an example and any usage of the display screens can be used for any purpose.

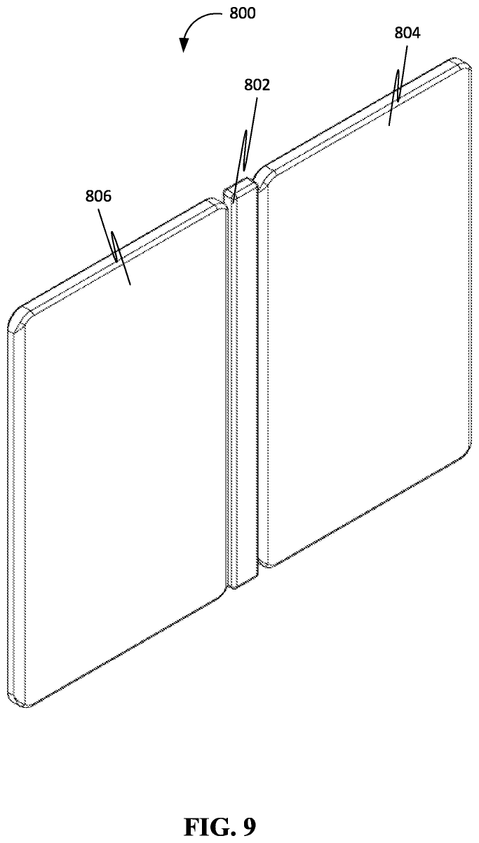

FIG. 9 is a rear top left side perspective view of the digicational smart book 800 for facilitating providing education to the user in the open configuration, in accordance with some embodiments.

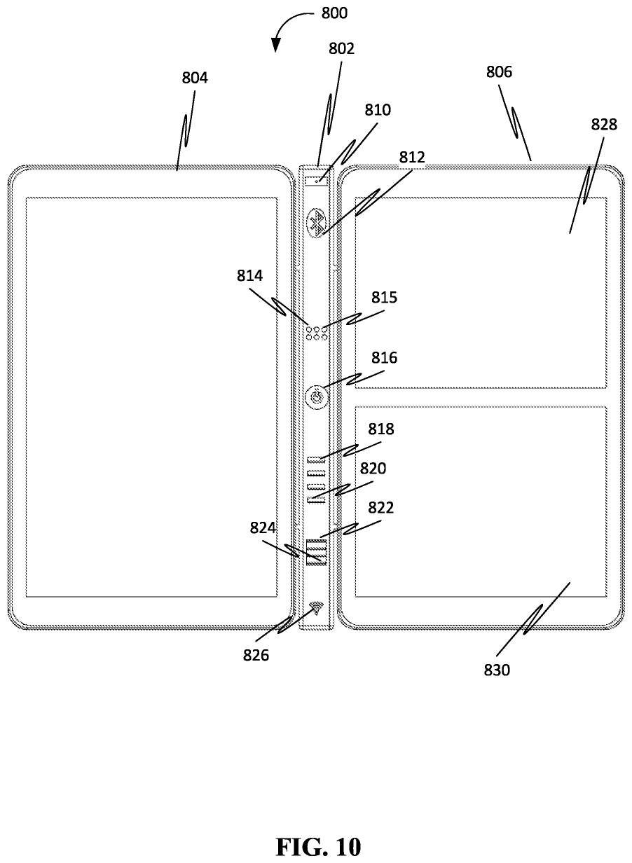

FIG. 10 is a front view of the digicational smart book 800 for facilitating providing education to the user in the open configuration, in accordance with some embodiments.

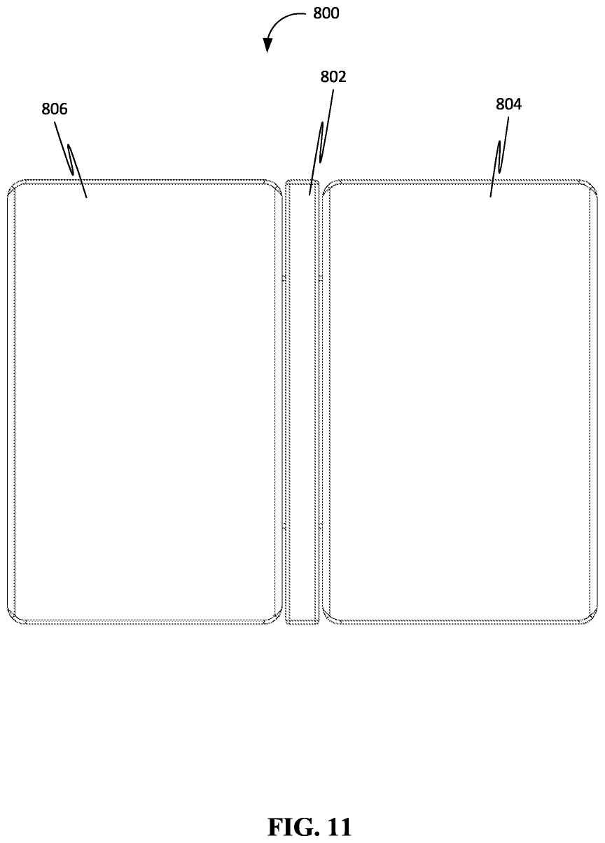

FIG. 11 is a rear view of the digicational smart book 800 for facilitating providing education to the user in the open configuration, in accordance with some embodiments.

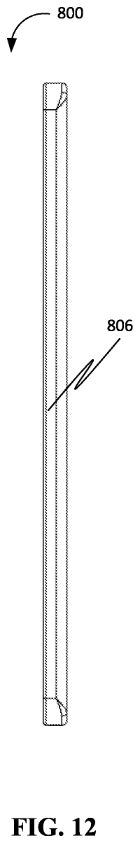

FIG. 12 is a right-side view of the digicational smart book 800 for facilitating providing education to the user in the open configuration, in accordance with some embodiments.

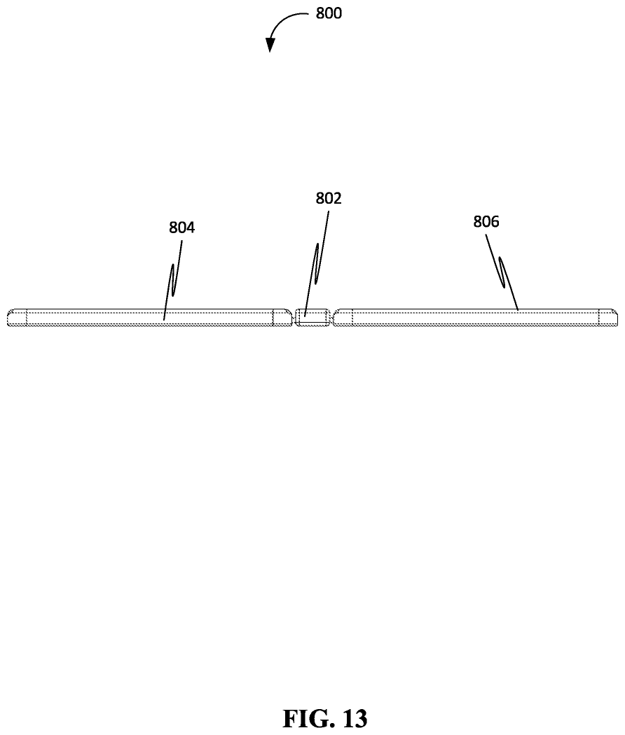

FIG. 13 is a bottom view of the digicational smart book 800 for facilitating providing education to the user in the open configuration, in accordance with some embodiments.

FIG. 14 is a front top left side perspective view of the digicational smart book 800 for facilitating providing education to the user in the open configuration, in accordance with some embodiments.

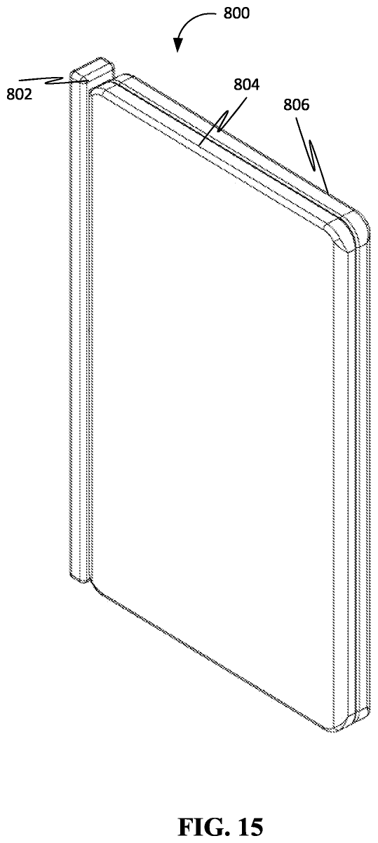

FIG. 15 is a front top right side perspective view of the digicational smart book 800 for facilitating providing education to the user in a closed configuration, in accordance with some embodiments.

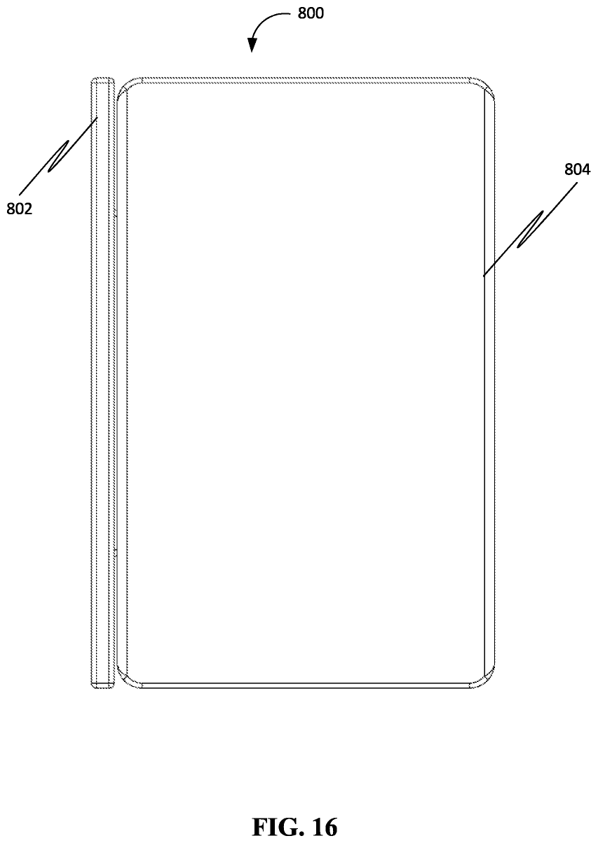

FIG. 16 is a front view of the digicational smart book 800 for facilitating providing education to the user in the closed configuration, in accordance with some embodiments.

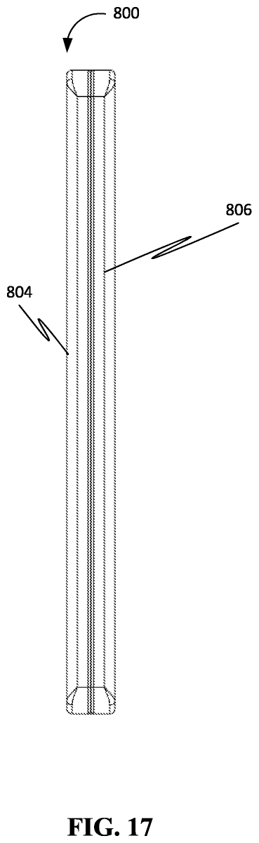

FIG. 17 is a right-side view of the digicational smart book 800 for facilitating providing education to the user in the closed configuration, in accordance with some embodiments.

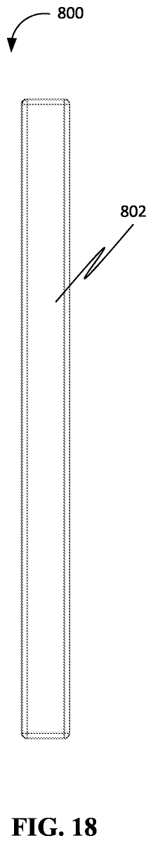

FIG. 18 is a left-side view of the digicational smart book 800 for facilitating providing education to the user in the closed configuration, in accordance with some embodiments.

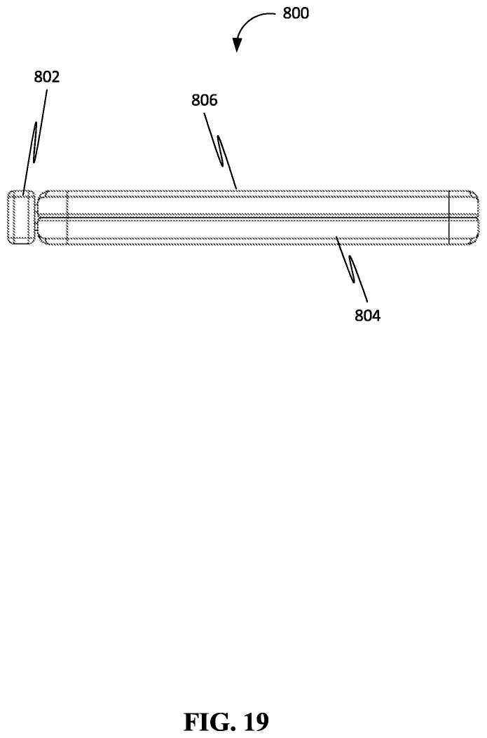

FIG. 19 is a bottom view of the digicational smart book 800 for facilitating providing education to the user in the closed configuration, in accordance with some embodiments.

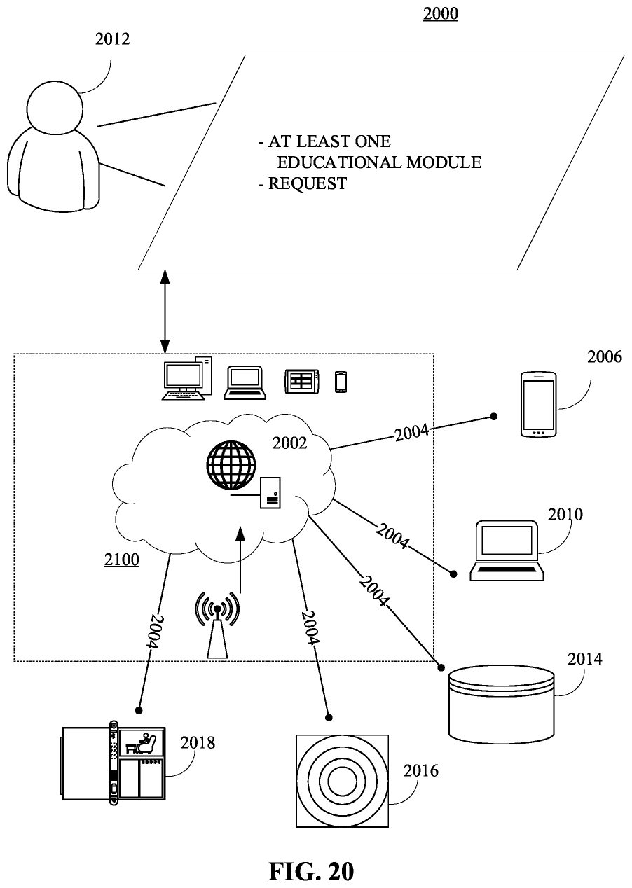

FIG. 20 is an illustration of an online platform 2000 consistent with various embodiments of the present disclosure. By way of non-limiting example, the online platform 2000 for facilitating providing education to a user may be hosted on a centralized server 2002, such as, for example, a cloud computing service. The centralized server 2002 may communicate with other network entities, such as, for example, a mobile device 2006 (such as a smartphone, a laptop, a tablet computer etc.), other electronic devices 2010 (such as desktop computers, server computers etc.), databases 2014, sensors 2016, a device 2018 (such as the digicational smart book for facilitating providing education to a user) over a communication network 2004, such as, but not limited to, the Internet. Further, users of the online platform 2000 may include relevant parties such as, but not limited to, end-users, administrators, service providers, service consumers and so on. Accordingly, in some instances, electronic devices operated by the one or more relevant parties may be in communication with the platform.

A user 2012, such as the one or more relevant parties, may access online platform 2000 through a web based software application or browser. The web based software application may be embodied as, for example, but not be limited to, a website, a web application, a desktop application, and a mobile application compatible with a computing device 2100.

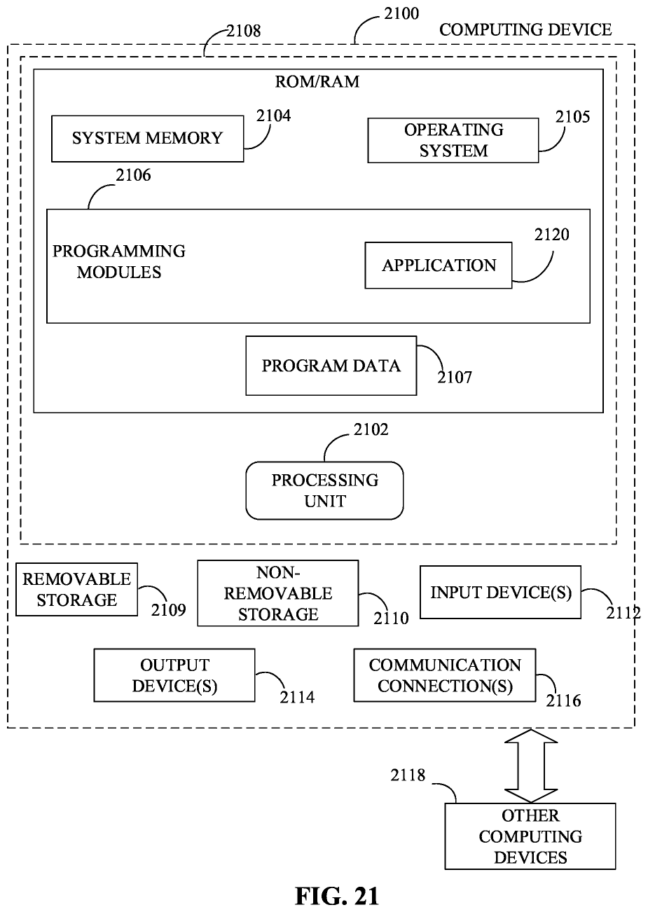

With reference to FIG. 21, a system consistent with an embodiment of the disclosure may include a computing device or cloud service, such as computing device 2100. In a basic configuration, computing device 2100 may include at least one processing unit 2102 and a system memory 2104. Depending on the configuration and type of computing device, system memory 2104 may comprise, but is not limited to, volatile (e.g. random-access memory (RAM)), non-volatile (e.g. read-only memory (ROM)), flash memory, or any combination. System memory 2104 may include operating system 2105, one or more programming modules 2106, and may include a program data 2107. Operating system 2105, for example, may be suitable for controlling computing device 2100's operation. In one embodiment, programming modules 2106 may include image-processing module, machine learning module. Furthermore, embodiments of the disclosure may be practiced in conjunction with a graphics library, other operating systems, or any other application program and is not limited to any particular application or system. This basic configuration is illustrated in FIG. 21 by those components within a dashed line 2108.

Computing device 2100 may have additional features or functionality. For example, computing device 2100 may also include additional data storage devices (removable and/or non-removable) such as, for example, magnetic disks, optical disks, or tape. Such additional storage is illustrated in FIG. 21 by a removable storage 2109 and a non-removable storage 2110. Computer storage media may include volatile and non-volatile, removable and non-removable media implemented in any method or technology for storage of information, such as computer-readable instructions, data structures, program modules, or other data. System memory 2104, removable storage 2109, and non-removable storage 2110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2100. Any such computer storage media may be part of device 2100. Computing device 2100 may also have input device(s) 2112 such as a keyboard, a mouse, a pen, a sound input device, a touch input device, a location sensor, a camera, a biometric sensor, etc. Output device(s) 2114 such as a display, speakers, a printer, etc. may also be included. The aforementioned devices are examples and others may be used.

Computing device 2100 may also contain a communication connection 2116 that may allow device 2100 to communicate with other computing devices 2118, such as over a network in a distributed computing environment, for example, an intranet or the Internet. Communication connection 2116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2104, including operating system 2105. While executing on processing unit 2102, programming modules 2106 (e.g., application 2120 such as a media player) may perform processes including, for example, one or more stages of methods, algorithms, systems, applications, servers, databases as described above. The aforementioned process is an example, and processing unit 2102 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A digicational smart book for facilitating providing education to a user, the digicational smart book comprising:
a front cover comprising at least one first receptacle for receiving at least one front screen, wherein the front cover is detachably attachable to a spine on a left side of the spine using a first coupling mechanism, wherein a first front part of the first coupling mechanism is attachable to the front cover and a second front part of the first coupling mechanism is attachable to the spine, wherein the first front part is coupled with the second front part in a first attached state;
a rear cover comprising at least one second receptacle for receiving at least one rear screen, wherein the rear cover is detachably attachable to the spine on a right side of the spine using a second coupling mechanism, wherein a first rear part of the second coupling mechanism is attachable to the rear cover and a second rear part of the second coupling mechanism is attachable to the spine, wherein the first rear part is coupled with the second rear part in a second attached state;
an input device configured to receive a request from at least one user;
the spine detachably attachable to the front cover and the rear cover, wherein the spine allows at least one of the front cover and the rear cover to pivotally rotate around a vertical axis of the spine, wherein the spine comprising:
a processing device communicatively coupled with the input device, wherein the processing device is configured for processing the request;
a storage device communicatively coupled with the processing device, wherein the storage device is configured for retrieving at least one educational module based on the processing of the request; and
a communication device communicatively coupled with each of the at least one front screen, the at least one rear screen and the processing device, wherein the communication device is configured for transmitting the at least one educational module to at least one of the at least one front screen and the at least one rear screen, wherein the at least one front screen and the at least one rear screen is configured for displaying the at least one education module; and
at least one power source configured to provide electrical energy to each of the at least one front screen, the at least one rear screen, the communication device, the processing device, and the storage device.

2. The digicational smart book of claim 1, wherein the spine further comprises a keyboard projector device disposed on the spine, wherein the keyboard projector device comprises:
an optical projector configured for projecting a keyboard on a surface; and
an optical receiver configured for generating reflection data based on receiving light reflected from the surface, wherein the processing device is configured for analyzing the reflection data for generating a textual content.

3. The digicational smart book of claim 1, wherein the spine further comprises at least one bluetooth indicator disposed on the spine, wherein the at least one Bluetooth indicator is communicatively coupled to the processing device, wherein the at least one Bluetooth indicator is configured for visually indicating a connectivity status of at least one external Bluetooth device with the digicational smart book, wherein the communication device comprises a Bluetooth transceiver, wherein the processing device is configured for determining the connectivity status.

4. The digicational smart book of claim 1, wherein the spine further comprises at least one Wi-Fi indicator disposed on the spine, wherein the at least one Wi-Fi indicator is communicatively coupled to the processing device, wherein the at least one Wi-Fi indicator is configured for visually indicating a network connectivity status of the digicational smart book with at least one Wi-Fi network, wherein the communication device comprises a Wi-Fi transceiver, wherein the processing device is configured for determining the network connectivity status.

5. The digicational smart book of claim 1, wherein the spine further comprises at least one image sensor communicatively coupled with the processing device, wherein the at least one image sensor is configured for generating at least one image data.

6. The digicational smart book of claim 1 further comprising at least one solar panel configured for generating electrical power using solar energy, wherein the at least one solar panel is disposed on the digicational smart book, wherein the at least one solar panel is electrically coupled with the at least one power source, wherein the at least one power source is configured to be recharged using the electrical power.

7. The digicational smart book of claim 1, wherein the at least one front screen is pivotally coupled to the front cover using at least one first flipping mechanism, wherein the at least one first flipping mechanism is configured for rotating the at least one front screen around an axis.

8. The digicational smart book of claim 1, wherein the at least one rear screen is pivotally coupled to the rear cover using at least one second flipping mechanism, wherein the at least one second flipping mechanism is configured for rotating the at least one rear screen around an axis.

9. The digicational smart book of claim 1, wherein the spine further comprises a plurality of ports communicatively coupled with the processing device, wherein the plurality of ports comprises audio ports, microphone ports, audio line-in ports, audio line-out ports, USB ports, and memory card ports.

10. A digicational smart book for facilitating providing education to a user, the digicational smart book comprising:
a front cover comprising at least one first receptacle for receiving at least one front screen, wherein the front cover is detachably attachable to a spine on a left side of the spine using a first coupling mechanism, wherein a first front part of the first coupling mechanism is attachable to the front cover and a second front part of the first coupling mechanism is attachable to the spine, wherein the first front part is coupled with the second front part in a first attached state;
a rear cover comprising at least one second receptacle for receiving at least one rear screen, wherein the rear cover is detachably attachable to the spine on a right side of the spine using a second coupling mechanism, wherein a first rear part of the second coupling mechanism is attachable to the rear cover and a second rear part of the second coupling mechanism is attachable to the spine, wherein the first rear part is coupled with the second rear part in a second attached state;
an input device configured to receive a request from at least one user;
the spine detachably attachable to the front cover and the rear cover, wherein the spine allows at least one of the front cover and the rear cover to pivotally rotate around a vertical axis of the spine, wherein the spine comprising:
a processing device communicatively coupled with the input device, wherein the processing device is configured for processing the request;
a storage device communicatively coupled with the processing device, wherein the storage device is configured for retrieving at least one educational module based on the processing of the request;
a communication device communicatively coupled with each of the at least one front screen, the at least one rear screen and the processing device, wherein the communication device is configured for transmitting the at least one educational module to at least one of the at least one front screen and the at least one rear screen, wherein the at least one front screen and the at least one rear screen is configured for displaying the at least one education module; and
a keyboard projector device disposed on the spine, wherein the keyboard projector device further comprises:
an optical projector configured for projecting a keyboard on a surface; and
an optical receiver configured for generating reflection data based on receiving light reflected from the surface, wherein the processing device is configured for analyzing the reflection data for generating a textual content; and
at least one power source configured to provide electrical energy to each of the at least one front screen, the at least one rear screen, the communication device, the processing device, and the storage device.

11. The digicational smart book of claim 10, wherein the spine further comprises at least one bluetooth indicator disposed on the spine, wherein the at least one Bluetooth indicator is communicatively coupled to the processing device, wherein the at least one Bluetooth indicator is configured for visually indicating a connectivity status of at least one external Bluetooth device with the digicational smart book, wherein the communication device comprises a Bluetooth transceiver, wherein the processing device is configured for determining the connectivity status.

12. The digicational smart book of claim 10 further comprising at least one stand attachable to a rear surface of the digicational smart book, wherein the at least one stand is configured to releasably retain the digicational smart book at an angle with the surface.

13. The digicational smart book of claim 10 further comprising a plurality of individual mini-fans disposed on the digicational smart book, wherein the plurality of individual mini-fans is electrically coupled with the at least one power source, wherein the plurality of individual mini-fans is configured to circulate air and reduce a temperature of a surrounding of the digicational smart book.

14. The digicational smart book of claim 10 further comprising at least one solar panel configured for generating electrical power using solar energy, wherein the at least one solar panel is disposed on the digicational smart book, wherein the at least one solar panel is electrically coupled with the at least one power source, wherein the at least one power source is configured to be recharged using the electrical power.

15. The digicational smart book of claim 10, wherein the at least one front screen is pivotally coupled to the front cover using at least one first flipping mechanism, wherein the at least one first flipping mechanism is configured for rotating the at least one front screen around an axis.

16. The digicational smart book of claim 10, wherein the at least one rear screen is pivotally coupled to the rear cover using at least one second flipping mechanism, wherein the at least one second flipping mechanism is configured for rotating the at least one rear screen around an axis.

17. The digicational smart book of claim 10, wherein the spine further comprises a plurality of ports communicatively coupled with the processing device, wherein the plurality of ports comprises audio ports, microphone ports, audio line-in ports, audio line-out ports, USB ports, and memory card ports.

18. A digicational smart book for facilitating providing education to a user, the digicational smart book comprising:
a front cover comprising at least one first receptacle for receiving at least one front screen, wherein the front cover is detachably attachable to a spine on a left side of the spine using a first coupling mechanism, wherein a first front part of the first coupling mechanism is attachable to the front cover and a second front part of the first coupling mechanism is attachable to the spine, wherein the first front part is coupled with the second front part in a first attached state;
a rear cover comprising at least one second receptacle for receiving at least one rear screen, wherein the rear cover is detachably attachable to the spine on a right side of the spine using a second coupling mechanism, wherein a first rear part of the second coupling mechanism is attachable to the rear cover and a second rear part of the second coupling mechanism is attachable to the spine, wherein the first rear part is coupled with the second rear part in a second attached state;
an input device configured to receive a request from at least one user;
the spine detachably attachable to the front cover and the rear cover, wherein the spine allows at least one of the front cover and the rear cover to pivotally rotate around a vertical axis of the spine, wherein the spine comprising:
a processing device communicatively coupled with the input device, wherein the processing device is configured for processing the request;
a storage device communicatively coupled with the processing device, wherein the storage device is configured for retrieving at least one educational module based on the processing of the request;
a communication device communicatively coupled with each of the at least one front screen, the at least one rear screen and the processing device, wherein the communication device is configured for transmitting the at least one educational module to at least one of the at least one front screen and the at least one rear screen, wherein the at least one front screen and the at least one rear screen is configured for displaying the at least one education module; and
a keyboard projector device disposed on the spine, wherein the keyboard projector device further comprises:
an optical projector configured for projecting a keyboard on a surface; and
an optical receiver configured for generating reflection data based on receiving light reflected from the surface, wherein the processing device is configured for analyzing the reflection data for generating a textual content;
at least one power source configured to provide electrical energy to each of the at least one front screen, the at least one rear screen, the communication device, the processing device, and the storage device; and
at least one solar panel configured for generating electrical power using solar energy, wherein the at least one solar panel is disposed on the digicational smart book, wherein the at least one solar panel is electrically coupled with the at least one power source, wherein the at least one power source is configured to be recharged using the electrical power.

19. The digicational smart book of claim 18, wherein the spine further comprises at least one image sensor communicatively coupled with the processing device, wherein the at least one image sensor is configured for generating at least one image data.

20. The digicational smart book of claim 18, wherein the at least one front screen is pivotally coupled to the front cover using at least one first flipping mechanism, wherein the at least one first flipping mechanism is configured for rotating the at least one front screen around an axis.
